(19) United States
(12) Patent Application Publication
(10) Pub. No.: US 2010/0202017 A1
(43) Pub. Date: Aug. 12, 2010

(54) APPARATUS AND METHOD FOR DETERMINING COST ALLOCATION OF MAINTENANCE CONSUMABLE

(75) Inventor: Takashi Sano, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/698,334

(22) Filed: Feb. 2, 2010

(30) Foreign Application Priority Data
Feb. 10, 2009 (JP) 2009-028603

(51) Int. Cl. G06F 3/12

(52) U.S. Cl. 358/1.15

(57) ABSTRACT

At least the following process is performed in order to properly allocate a cost of a consumable used for other than jobs. An amount of the consumable used for other than jobs is determined, and a cost of the consumable corresponding to the determined amount of the consumable is allocated to costs of a plurality of jobs executed.

### BACKGROUND OF THE INVENTION

1. Field of the Invention

The present invention relates to an apparatus and method for determining cost allocation of a consumable that is used for other than jobs by a job processing device.

2. Description of the Related Art

Conventionally, for example in an inkjet printer, an ink head is cleaned to prevent nozzle clogging of the ink head. Ink is used during this cleaning. This ink is not ink used in normal print jobs. Ink is also used for maintenance of the ink head at a predetermined timing, other than during the cleaning. This ink is not ink used in print jobs, either.

When the inkjet printer is used by a plurality of users or sections, there is a demand to allocate a cost of ink used for maintenance among the individual users or sections. However, it is difficult to properly perform such allocation.

Japanese Patent Application Laid-Open No. 2007-26249 describes that a cost required for other than print jobs, such as a maintenance cost, is calculated according to a predetermined unit price, an amount of ink used and an amount of paper feed in a print job, and the like.

However, in the technique described in Japanese Patent Application Laid-Open No. 2007-26249, the cost is calculated according to the predetermined unit price, where an amount of ink used for other than print jobs is not taken into consideration. Therefore, a cost of ink actually used for other than print jobs cannot be properly allocated.

This problem is not limited to ink, but can also occur with regard to various consumables such as paper. Besides, the problem can occur not only in inkjet printers but also in other types of printers. Moreover, there can also be a cost required for other than consumables such as ink, toner, and paper. Furthermore, the problem can also occur in other than printers.

### SUMMARY OF THE INVENTION

One aspect of the present invention is to provide a data processing apparatus and method that can solve the above-mentioned problem.

Another aspect of the present invention is to provide a data processing apparatus and method that can properly allocate a cost of a consumable used for other than jobs.

The aspects of the present invention stated above will become apparent from the following detailed description based on the specification and drawings.

Further features of the present invention will become apparent from the following description of exemplary embodiments with reference to the attached drawings.

### BRIEF DESCRIPTION OF THE DRAWINGS

FIG. 1 is a block diagram illustrating a printer 100 which is an embodiment of the present invention.

FIG. 2 is a block diagram illustrating a structure example of external equipment 110.

FIG. 3 is a time chart illustrating maintenance ink consumption timings.

FIG. 4 is a view illustrating a panel device 109 in the printer 100.

FIG. 5 is a view illustrating an example of a panel display screen for inputting ink cost information.

FIG. 6 is a flowchart illustrating an operation in the embodiment.

FIG. 7 is a view illustrating an example of a screen displaying a used ink amount of each color and cost information for each job.

FIG. 8 is a view illustrating an example of a screen for inputting a maintenance ink allocation method by a user.

FIG. 9 is a view illustrating a screen in the case where maintenance ink is allocated equally for each job.

FIG. 10 is a view illustrating a screen in the case where maintenance ink is allocated.

FIG. 11 is a flowchart illustrating an operation that follows the flowchart illustrated in FIG. 6.

FIG. 12 is a view illustrating an example of a screen for allocating maintenance ink for each section.

FIG. 13 is a view illustrating a screen indicating a charge status of each user.

### DESCRIPTION OF THE EMBODIMENTS

Preferred embodiments of the present invention will now be described in detail in accordance with the accompanying drawings.

The following describes an embodiment of the present invention in detail, with reference to accompanying drawings. Note that a structure illustrated in the following embodiment is merely an example, and the present invention is not limited to the illustrated structure.

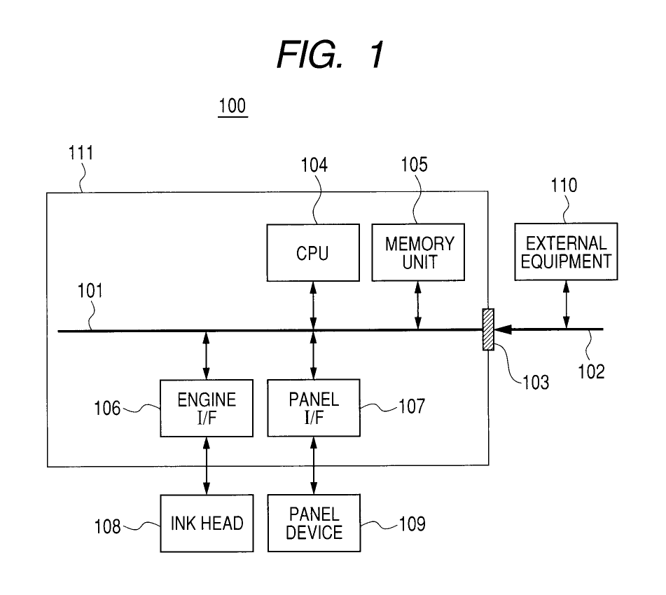

FIG. 1 is a block diagram illustrating a printer 100 which is an embodiment of the present invention. The printer 100 has both a function as a job processing device that executes jobs and a function as a data processing apparatus that performs charge processing for jobs.

The printer 100 includes a controller 111, an ink head 108, and a panel device 109.

The controller 111 is a unit that controls an operation of the printer 100, and includes an internal bus 101, a host I/F 103, a CPU 104, a memory unit 105, an I/F 106 which is an engine interface, and a panel I/F 107. The controller 111 is connected to external equipment 110 such as a PC via an external network 102, and receives image data from the external equipment 110.

The CPU 104 is a central processing unit that controls the entire controller 111 according to a program stored in the memory unit 105 in advance, mode designation from the panel device 109, or a command (instruction) from the external equipment 110. The CPU 104 also analyzes print data stored in the memory unit 105, and processes print job data and a printer control command.

The memory unit 105 is a storage device capable of holding the contents of mode designation from the panel device 109, print job data, and the like. The memory unit 105 may be a large-capacity storage device such as an HDD.

The engine I/F 106 is an interface module for communicating a command, a status and print data with the ink head 108.

The ink head 108 ejects ink to print an image on recording paper. How much ink of each color is used for printing and how much maintenance ink (ink used for maintenance of the printer 100) is used in the ink head 108 are calculated by the engine I/F 106, and used ink data of each color is stored in the memory unit 105.

The panel I/F 107 is an interface for communicating a command and a status with the panel device 109.

The panel device 109 is an operation panel for performing mode designation by an operator and notifying a current printer status to the operator. In this embodiment, ink cost information of each color can be input from the panel device 109. Moreover, an ink use status of each color, cost calculation information, charge information, and the like are displayed on the panel device 109. Furthermore, a user can arbitrarily select a cost calculation method or a charge method via the panel device 109. The determination of the charge method may be limited to authorized personnel such as service personnel, instead of being performed by the user.

The host I/F 103 is an interface for communicating with the external equipment 110. The host I/F 103 is a network interface, a USB interface, a 1394 interface, a Centronics interface, or the like.

The controller 111, upon receiving text information or image information from the external equipment 110, analyzes the received information and stores print data for each page of recording paper in the memory unit 105. This print data for each page of recording paper is output from the engine I/F 106 to the ink head 108, and an image corresponding to the print data is printed on recording paper.

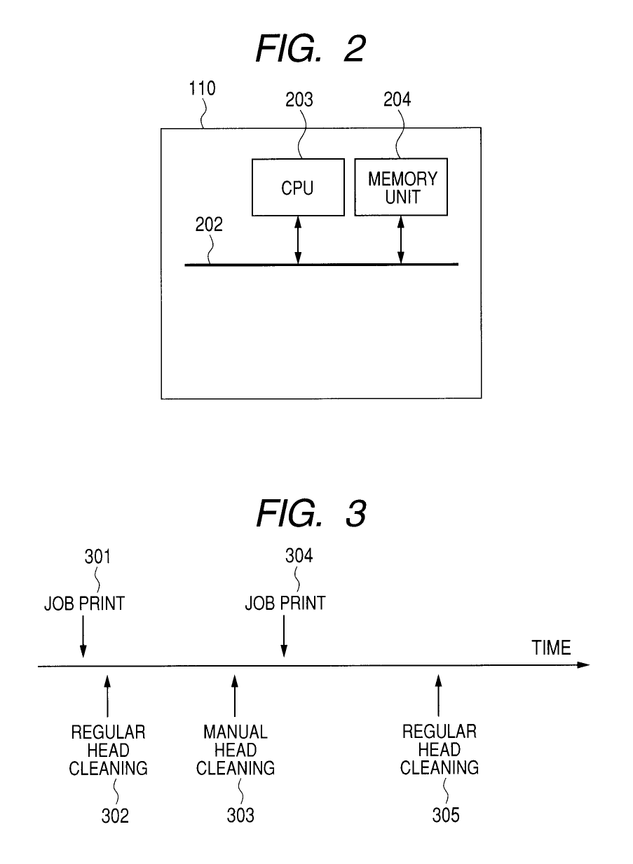

FIG. 2 is a block diagram illustrating a structure example of the external equipment 110.

The external equipment 110 includes a CPU 203 and a memory unit 204 that are connected by an internal bus 202.

FIG. 3 is a time chart illustrating timings at which maintenance ink is consumed according to maintenance in this embodiment, with a horizontal axis representing time. Maintenance ink is consumed by head cleaning 302 that is automatically started on a regular basis, head cleaning 303 that is started by a start instruction from the user, and so on. In addition, maintenance ink is consumed on an irregular basis, depending on a use environment (a printing frequency, a temperature, a humidity) and the like.

FIG. 4 is a view illustrating an example of the panel device 109 provided in the printer 100.

The panel device 109 includes a liquid crystal display 402, an instruction determination button 403, and a selection button 404.

The liquid crystal display 402 displays various operations and messages. The user selects a desired instruction via the selection button 404, and executes the instruction via the instruction determination button 403.

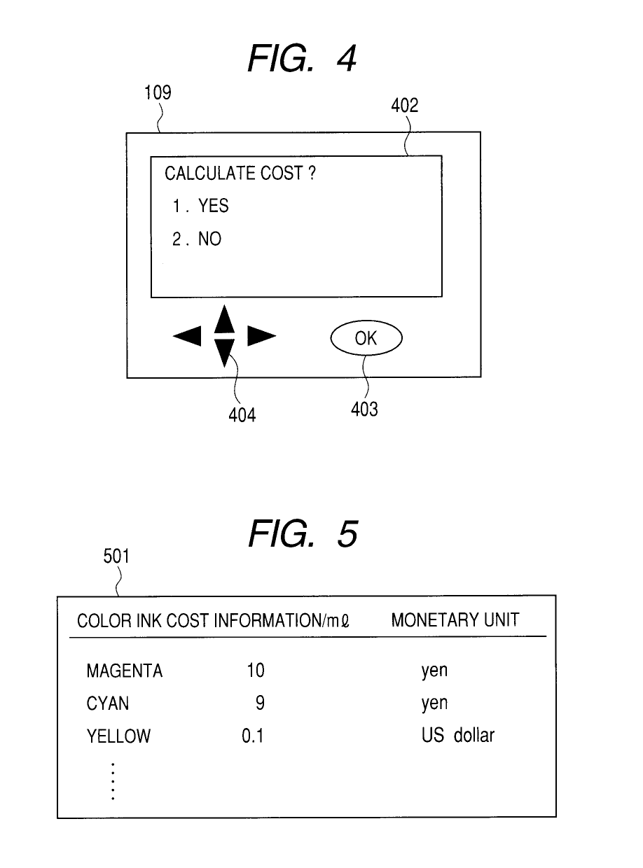

FIG. 5 is a view illustrating an example of a panel display screen 501 for displaying ink cost information of each color, in the case of inputting ink cost information of each color via the panel device 109.

In the example illustrated in FIG. 5, cost information of ink of each color (magenta, cyan, yellow) per ml can be input in both Japanese yen and US dollar. Ink colors other than magenta, cyan, and yellow and monetary units other than Japanese yen and US dollar may be adapted.

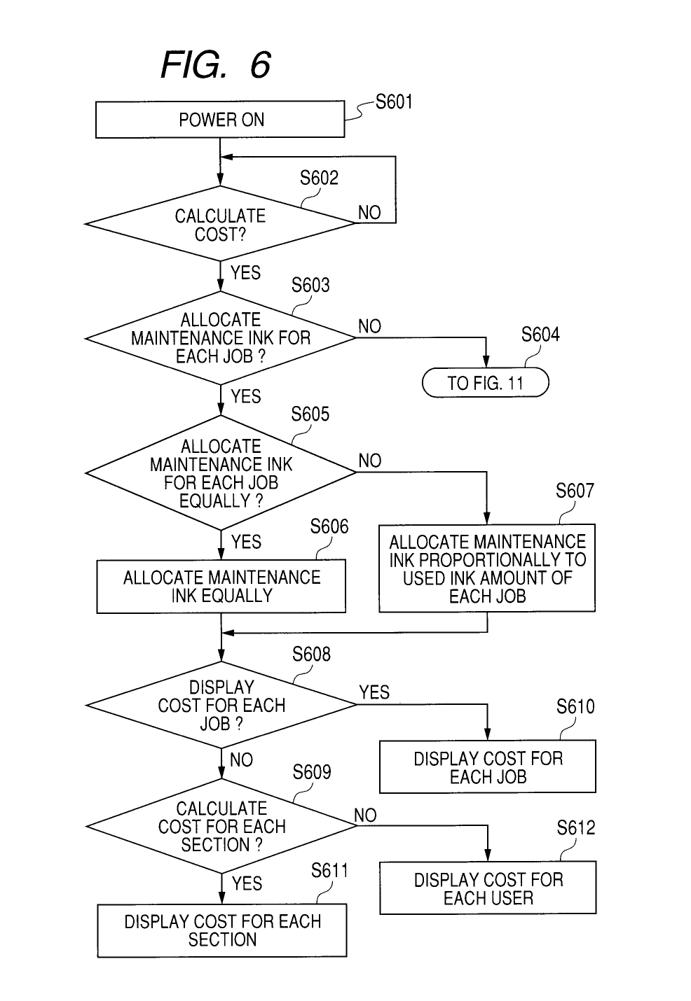

FIG. 6 is a flowchart illustrating an operation in this embodiment. This flowchart indicates a processing flow according to which the CPU 104 performs control based on the program stored in the memory unit 105.

In step S601, the printer 100 is powered on. An amount of ink used for each of a plurality of print jobs previously executed in the printer 100 and an amount of maintenance ink used for a plurality of maintenance operations in the printer 100 are stored in the memory unit 105 of the printer 100 powered on. These used ink amounts are determined by the CPU 104 and the determination results are stored in the memory unit 105. Hereafter, it is assumed that ink amounts which are stored in the memory unit 105 and for which charge processing has not yet been completed are subject to cost calculation. When an instruction to perform cost calculation is made by the user in step S602, whether or not to allocate (assign) cost calculation target maintenance ink for each cost calculation target job is determined by the user in step S603. In the case of not allocating the cost calculation target maintenance ink for each cost calculation target job, the processing proceeds to step S604.

The “cost calculation target maintenance ink” referred to here is, for example, ink used as maintenance ink that has not yet been employed for charge processing. An amount of ink used as maintenance ink is determined, and a cost of the used amount is allocated to costs of print jobs. In the case of allocating the cost calculation target maintenance ink for each cost calculation target job, whether or not to allocate the cost calculation target maintenance ink equally for each cost calculation target job is determined by the user in step S605.

In the case of allocating the cost calculation target maintenance ink equally for each job, a process of allocating the amount of ink used as the cost calculation target maintenance ink equally for each cost calculation target job is performed in step S606.

In the case of not allocating the cost calculation target maintenance ink equally for each cost calculation target job, a process of unequally allocating the cost calculation target maintenance ink proportionally to the used ink amount of each cost calculation target job is executed in step S607. After this, whether or not to display a cost for each job is determined by the user in step S608.

In the case of displaying the cost for each job, a cost of each job as a result of allocating the maintenance ink for each job is displayed on the panel device 109 in step S610. In the case of not displaying the cost for each job, whether or not to calculate a cost for each section is determined by the user in step S609.

In the case of calculating the cost for each section, cost calculation is performed for each section and a cost of each section as a result of allocating the maintenance ink for each section is displayed on the panel device 109 in step S611. In the case of not calculating the cost for each section, a cost of each person (user) as a result of allocating the maintenance ink for each user is calculated and displayed on the panel device 109 in step S612.

Though the unit (attribute) of job cost is set to be at least any one of a print job, a section, and a user, the unit of job cost may be a project regardless of a section, or other units. Moreover, a time period such as a month or a half year can be set as the unit of cost calculation.

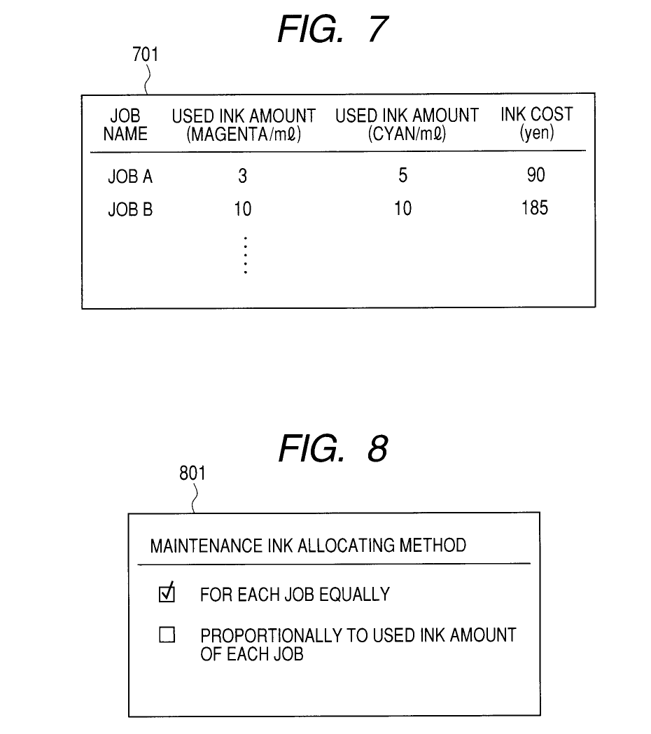

FIG. 7 is a view illustrating an example of a panel display screen 701 in the case where a used ink amount of each color and cost information are displayed for each job on the panel device 109 in this embodiment.

This display enables the user to know amounts of ink of magenta and cyan used in each of job A and job B and ink cost information of each of job A and job B. This example indicates a result of allocating maintenance ink for ink used in each job.

FIG. 8 is a view illustrating an example of a screen displayed as a panel display screen 801 on the panel device 109 in the case where the user inputs a maintenance ink allocation method via the panel device 109 in this embodiment.

In this embodiment, two choices are available, namely, whether maintenance ink is allocated equally for each job or allocated proportionally to a used ink amount. By checking a checkbox corresponding to a desired method on the panel display screen 801, the user can determine the method. This process is an example of the process of step S605 in the flowchart illustrated in FIG. 6.

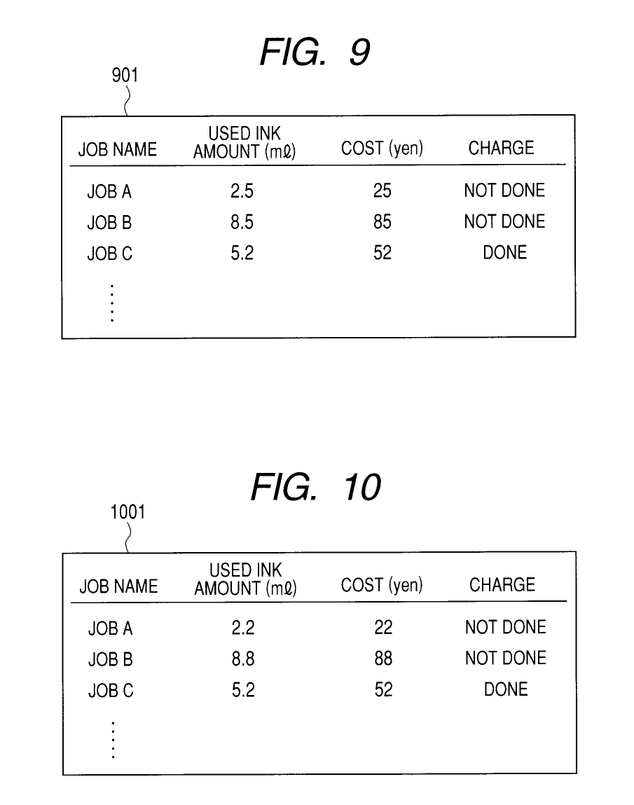

FIG. 9 is a view illustrating a panel display screen 901 displayed on the panel device 109 in the case where maintenance ink is allocated equally for each job in this embodiment.

When the cost of ink is 1 ml=10 yen (suppose here that the cost is the same for each color), a total amount of ink used for printing of all ink colors in job A is 2 ml, and a total amount of ink used for printing of all ink colors in job B is 8 ml.

Here, a “done” flag in a charge entry is stored in the memory unit 105 for a job that has already been charged according to a cost calculation result. In FIG. 9 (and also in FIG. 10), job C is an already charged job. The maintenance ink allocation is performed only on uncharged jobs, and charged jobs are not subject to the maintenance ink allocation. This is intended to prevent a situation where a cost calculation result of an already charged job changes and as a result charge processing becomes complex, given that the maintenance ink allocation causes a change in cost calculation result. As illustrated in FIG. 9 (and also in FIG. 10), there are two uncharged (cost calculation target) jobs, namely, job A and job B. These two jobs are subject to cost calculation. A total amount of color maintenance ink used from the previous charge up to the present is 1 ml, so that ½=0.5 ml is added to the total used color ink amount of each of job A and job B. Therefore, the total used color ink amount of job A is 2+0.5=2.5 ml, and the total used color ink amount of job B is 8+0.5=8.5 ml.

The total amount of color maintenance ink used is not displayed on the panel display screen 901. As a result of performing cost calculation based on this result, the cost of job A is calculated at 25 yen, and the cost of job B is calculated at 85 yen.

FIG. 10 is a view illustrating a display example of a panel display screen 1001 on the panel device 109 in the case where maintenance ink is allocated proportionally to the used ink amount of each cost calculation target job in this embodiment.

As in the above-mentioned case, when the cost of ink is 1 ml=10 yen, a total amount of ink used for printing of all ink colors in job A is 2 ml, and a total amount of ink used for printing of all ink colors in job B is 8 ml. Since there are two uncharged jobs, namely, job A and job B, these two jobs are cost calculation target jobs.

The cost of maintenance ink is allocated at 2:8=1:4, which is a proportion of job A and job B in used ink amount. A total amount of color maintenance ink used from the previous charge up to the present is 1 ml. This being so, a used maintenance ink amount of 1×1/(1+4)=0.2 ml is added to job A, and a used maintenance ink amount of 1×4/(1+4)=0.8 ml is added to job B. Therefore, the total used color ink amount of job A is 2+0.2=2.2 ml, and the total used color ink amount of job B is 8+0.8=8.8 ml.

The total amount of color maintenance ink used is not displayed on the panel display screen 1001. As a result of performing cost calculation based on this result, the cost of job A is calculated at 22 yen, and the cost of job B is calculated at 88 yen.

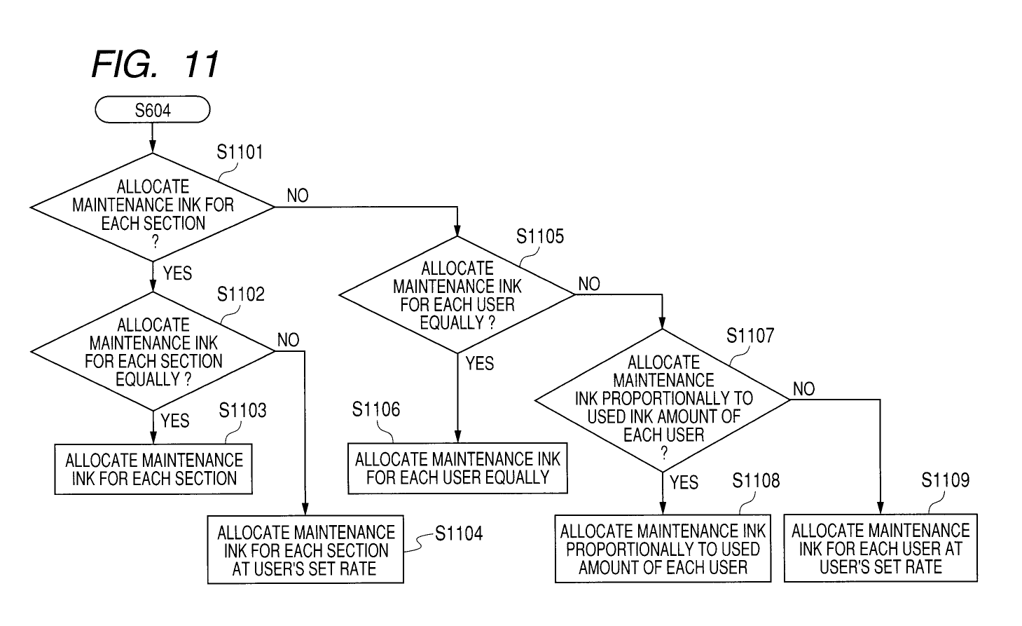

FIG. 11 is a flowchart illustrating an operation that follows the flowchart illustrated in FIG. 6.

In the case of not allocating the cost calculation target maintenance ink for each cost calculation target job, whether or not to allocate the cost calculation target maintenance ink for each section is determined by the user in step S1101. In the case of allocating the maintenance ink for each section, whether or not to allocate the maintenance ink equally for each section is determined by the user in step S1102. In the case of allocating equally, the maintenance ink is allocated equally for each section in step S1103. In the case of not allocating equally, the maintenance ink is allocated for each section at a rate set by the user in step S1104.

When the user determines not to allocate the maintenance ink for each section in step S1101, whether or not to allocate the maintenance ink equally for each person (each user) is determined by the user (operator) in step S1105. In the case of allocating the maintenance ink equally for each user, the maintenance ink is allocated equally for each user in step S1106.

In the case of not allocating the maintenance ink equally for each user, whether or not to allocate the maintenance ink proportionally to the used ink amount of each user is determined by the user in step S1107. In the case of allocating the maintenance ink proportionally to the used ink amount of each user, the maintenance ink is allocated proportionally to the used ink amount of each user in step S1108. In the case of not allocating the maintenance ink proportionally to the used ink amount of each user, the maintenance ink is allocated for each user at a rate set by the user in step S1109.

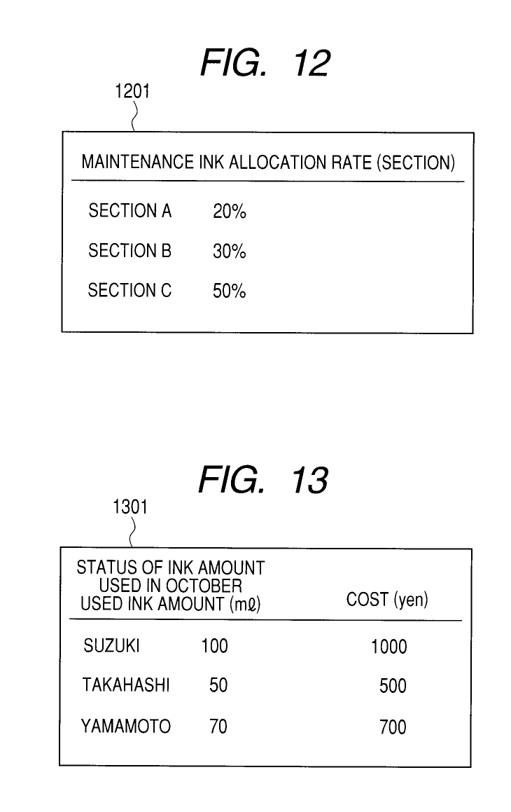

FIG. 12 is a view illustrating a display example of a panel display screen 1201 on the panel device 109 in the case where maintenance ink is allocated for each section that uses the printer 100 in this embodiment.

The panel display screen 1201 represents a panel display screen in the case where maintenance ink is allocated for section A at a rate of 20%, section B at a rate of 30%, and section C at a rate of 50%. The user can add or delete a section that is subject to allocation, and also arbitrarily set a rate of allocation.

FIG. 13 is a view illustrating a panel display screen 1301 on the panel device 109 for displaying a cost list in the case where cost calculation is performed for each user (each person) in this embodiment. In charge processing performed based on the result of cost calculation, each user is charged for the amount of money displayed on this screen.

The panel display screen 1301 indicates a monthly cost for each user when the cost of ink of each color is 1 ml=10 yen.

Though all functions relating to the above-mentioned processing are included in the printer 100 in the embodiment described above, there is no need to include all functions in the printer 100.

In detail, though the cost calculation result is output via the panel I/F 107 and displayed on a display unit of the panel device 109, the present invention is not limited to this. The cost calculation result may be output via the host I/F 103 and transmitted to the external equipment 110 (a host PC or a server) so that the external equipment 110 displays the cost calculation result and performs charge processing.

Moreover, as a modification to the above-mentioned embodiment, the printer 100 may be constructed in cooperation with the external equipment 110 illustrated in FIG. 1. In such a case, the controller 110 transmits the amounts of ink used for each print job and maintenance to the external equipment 110 via the external network 102 such as a network line so that the external equipment 110 performs cost calculation as described earlier.

Moreover, the memory unit 105 for storing the used ink amount of each color, the input of the ink unit price of each color, or the memory unit 105 for storing the ink unit price of each color may be provided in the external equipment 110. Moreover, a process of allocating the amount of ink used for other than printing as the used ink amount belonging to each print job, each user, or each section according to a predetermined condition may be provided in the external equipment 110. Moreover, cost calculation or charge processing for each job, each user, or each section based on the ink unit price of each color may be performed in the external equipment 110. Alternatively, these functions may be provided in separate apparatuses.

In the case of performing the above-mentioned charge processing in the external equipment 110, the program according to the above-mentioned flowcharts is held in the memory unit 204 and processed by the CPU 203 in the external equipment 110.

The program executed in the printer 100 or the external equipment 110 may be executed by one CPU or by a plurality of CPUs in cooperation. Moreover, software and hardware may be appropriately combined to execute processing.

The display screen of the panel device 109 included in the printer 100 is limited in size. Accordingly, by providing these functions in the external equipment 110 such as a PC, a system of higher operability and higher performance can be created.

According the embodiment described above, by allocating a used maintenance ink amount in an inkjet printer in which maintenance ink is used, the effect of enabling more accurate and equitable cost calculation can be achieved.

In the above description, ink is an example of a consumable that is used for other than print jobs. However, the present invention is not limited to this. The consumable may be toner used in electrophotographic printing, or recording paper. Other consumables are also applicable. Alternatively, a consumable other than a recording material such as recording paper and a recording agent including ink and toner may be used. Moreover, a cost required for other than such consumables may be allocated. The present invention may also be applied to allocation of a cost required for other than job execution in a job processing device that executes jobs other than printing.

The present invention is not limited to the above-mentioned embodiment but can be modified in various manners (including an organic combination of embodiments) based on the spirit of the present invention, and the various modifications are not excluded from the scope of the present invention.

Although various examples and embodiments of the present invention have been illustrated and described, those skilled in the art will understand that the spirit and scope of the present invention are not limited to a particular description in this specification.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-028603, filed Feb. 10, 2009, which is hereby incorporated by reference herein in its entirety.

What is claimed is:

1. A data processing apparatus comprising:
a determination unit configured to determine an amount of a predetermined consumable used for other than job execution in a job processing device; and
an allocation unit configured to allocate a cost of the predetermined consumable corresponding to the amount of the predetermined consumable determined by the determination unit, to costs of a plurality of jobs executed in the job processing device.

2. The data processing apparatus as claimed in claim 1, wherein the job processing device executes a print job using a recording agent as the predetermined consumable, and the determination unit determines an amount of the recording agent used for maintenance of the job processing device.

3. The data processing apparatus as claimed in claim 1, wherein the allocation unit allocates the cost of the predetermined consumable used for other than the job execution, equally to the costs of the plurality of jobs executed in the job processing device.

4. The data processing apparatus as claimed in claim 1, wherein the allocation unit allocates the cost of the predetermined consumable used for other than the job execution, according to an amount of the predetermined consumable used in each of the plurality of jobs executed in the job processing device.

5. The data processing apparatus as claimed in claim 1, wherein the allocation unit allocates the cost of the predetermined consumable used for other than the job execution to the costs of the plurality of jobs executed in the job processing device, at a designated rate.

6. The data processing apparatus as claimed in claim 1, wherein the allocation unit allocates the cost for each user or section that uses the job processing device.

7. A data processing method comprising:
determining an amount of a predetermined consumable used for other than job execution in a job processing device; and
allocating a cost of the predetermined consumable corresponding to the determined amount of the predetermined consumable, to costs of a plurality of jobs executed in the job processing device.

8. A computer readable storage medium storing a computer executable program, the program comprising:
determining an amount of a predetermined consumable used for other than job execution in a job processing device; and
allocating a cost of the predetermined consumable corresponding to the determined amount of the predetermined consumable, to costs of a plurality of jobs executed in the job processing device.
